(19) United States
(12) Patent Application Publication
(10) Pub. No.: US 2010/0230883 A1
(43) Pub. Date: Sep. 16, 2010

(54) Workpiece clamping device

(76) Inventors: Edgar Fries, Berlin (DE); Jan-Mark Lischka, Berlin (DE); Eckart Uhlmann, Kiebitzreihe (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/721,596

(22) Filed: Mar. 11, 2010

(30) Foreign Application Priority Data
Mar. 12, 2009 (EP) 09003634.4

(51) Int. Cl. B23Q 3/00; B25B 1/20

(52) U.S. Cl. 269/131; 269/309

(57) ABSTRACT

A workpiece clamping device for clamping a workpiece during machining is provided. The workpiece may be a turbine blade in the region of the blade airfoil. The workpiece clamping device includes a basic body with a workpiece seat, wherein provision is made for at least one clamping strap for clamping the workpiece.

### CROSS REFERENCE TO RELATED APPLICATIONS

This application claims priority of European Patent Office application No. 09003634.4 EP filed Mar. 12, 2009, which is incorporated by reference herein in its entirety.

### FIELD OF INVENTION

The present invention refers to a workpiece clamping device for clamping a workpiece during machining, especially a turbine blade clamping device for clamping a turbine blade in the region of the blade airfoil, which device has a basic body with a workpiece seat.

### BACKGROUND OF INVENTION

The production of turbine blades is known in the prior art. For this, a blank of the turbine blade is cast in a first step. The blade airfoil of the blank is then fixed in a workpiece clamping device and the final geometry of the blade root is formed by material removal, for example by grinding, milling or the like.

For the clamping of blade airfoils of a complicated shape various clamping techniques are used, such as casting into low melting alloys, hard clamping by means of clamping levers, or so-called pin-type clamping.

In the case of casting into low melting alloys the blade airfoil is cast into a block consisting of a low melting metal alloy. After solidifying of the block, this can be clamped by means of conventional workpiece clamping devices so that the blade root can be machined without any problem. After the machining of the workpiece, the low melting alloy can be recovered again and then reused. A disadvantage of this technique is that both the casting of the blade airfoil into the low melting alloy and also the removing of the alloy block after the machining of the blade airfoil are very complex which is why this method is very time-intensive and expensive.

A workpiece clamping device for hard clamping by means of clamping levers is disclosed for example in US 2003/0114080 A1. In the case of this workpiece clamping device, positioning of the blade airfoil is carried out by means of stops which are faulted on a basic body of the workpiece clamping device. During this, the blade airfoil is first supported against a first set of stops which prevent movement of the workpiece in the direction which is perpendicular to a plane of the basic body. After that, a movable clamping lever is operated which presses the blade airfoil against further sets of stops which prevent movement of the blade airfoil within the plane of the basic body. In this case also, it is disadvantageous that the workpiece clamping device is constructionally complex and therefore expensive.

In the case of the pin-type clamping technique, the complex geometry of the blade airfoil on one reference side is supported on a multiplicity of support points by means of support elements which consist of pins. The workpiece is then aligned with regard to an inner axis by displacing the support elements in their vertical position, whereupon on support points of the opposite side the multiplicity of support elements there are brought to abut against the surface profile there. At the same time, the support elements of the two sides are tensioned towards each other. For this, the workpiece clamping device comprises two tensioning units which face each other, wherein the pins are mounted in a sealed manner in guide plates, project into a pressure chamber and are under pressure of a fluid until the establishing of the applied pressure state. Such a workpiece clamping device is disclosed for example in DE 41 24 340 A1. A significant disadvantage of this technique is that the workpiece clamping device is constructionally very complex and correspondingly expensive.

### SUMMARY OF INVENTION

It is an object of the present invention to create a workpiece clamping device of the type referred to in the introduction which is cost-effective to produce. In addition, by means of the workpiece clamping device according to the invention short clamping times and good accessibility of the workpiece during the machining are to be realized. Moreover, the workpiece clamping device is to be formed so that geometry deviations of the workpiece, especially of a turbine blade blank, have no significant influence upon the clamping situation. Also, the workpiece clamping device according to the present invention is to be formed in such a way that manufacturing errors on account of incorrectly clamped workpieces are minimized.

For achieving this object, or objects, the present invention creates a workpiece clamping device of the type referred to in the introduction, in which provision is made for at least one clamping strap for clamping the workpiece. Such a clamping strap is advantageous to the effect that very short clamping times can be realized. Also, geometry deviations of the workpiece which is to be machined remain on account of the flexibility of the clamping strap without significant influence upon the clamping situation. On account of the low overall height of the clamping strap, moreover, a very good accessibility of the workpiece in the clamped state is achieved. In addition, the use of a clamping strap instead of a conventional clamp ensures a better rigidity/weight ratio and facilitates the handling of the workpiece clamping device. A clamping strap, moreover, has a large support surface and a large angle of wrap on the workpiece and, depending upon the strap material which is used, can achieve good damping and can avoid vibrations during workpiece machining.

The at least one clamping strap is preferably produced from a fibrous material. The fibrous material is advantageously a fabric with high resistance to tearing.

The at least one clamping strap can preferably be fixed on the basic body with capacity for adjustment in its clamping length. As a result of the variable clamping length, workpieces with a very wide variety of geometries can be clamped so that the workpiece clamping device according to the invention can be used in a very flexible manner.

The workpiece seat is preferably at least partially formed by means of support elements which define support points or support surfaces which are provided for the positioning of the workpiece. These support elements can either be formed in one piece with the basic body or can be fastened as separate components on the basic body.

Also, the workpiece seat can be at least partially defined by means of at least one support surface, the contour of which is at least partially geometrically adapted to an outer contour of a workpiece which is to be clamped, especially to the outer contour of a turbine blade airfoil, in order to achieve a predetermined positioning of the workpiece on the workpiece clamping device.

Provision is preferably made on the basic body for clamping devices for the fixing of the at least one clamping strap, such as in the form of two oppositely disposed clamping plates which can be screwed towards each other with the clamping strap positioned between these.

Provision is advantageously made for at least one automatic tensioning device which is formed in such a way that it automatically tensions the at least one clamping strap until achieving a predetermined clamping force. In this case, the predetermined clamping force is advantageously adjustable by the user.

According to one embodiment, the at least one tensioning device comprises a linear motor, on the piston rod of which a clamping device is fastened so that this is movable together with the piston rod in order to selectively tension or to slacken the associated clamping strap.

The basic body can be preferably detachably mounted on different workpiece processing machines. Accordingly, a workpiece which is retained on the basic body can be transported in the clamped state from one workpiece processing machine to another. The workpiece correspondingly remains in the workpiece clamping device during different process steps so that reclamping of the workpiece can be entirely dispensed with. In this way, manufacturing errors on account of incorrectly clamped workpieces can be minimized.

The basic body is preferably formed in such a way that it can be detachably mounted in a workpiece processing machine by using a zero-point clamping system.

The basic body preferably has at least one clamping element which interacts with a zero-point clamping system, especially in the fowl of a draw-in bolt.

According to one embodiment of the present invention, at least one workpiece support device, especially a blade root support device, can be fastened on the basic body in such a way that a support surface which is formed on this comes into contact with the workpiece.

According to a further embodiment, at least one cooling fluid guiding device can be fastened on the basic body in such a way that the fluid flow of a cooling fluid during material-removing machining of the workpiece is influenced in a predetermined manner.

### BRIEF DESCRIPTION OF THE DRAWINGS

With regard to further advantageous developments of the invention, the dependent claims and also the subsequent description of an exemplary embodiment are to be referred to with reference to the attached drawing. In the drawing

FIG. 1 shows a perspective view of a workpiece clamping device according to a first embodiment of the present invention, in which a turbine blade is clamped in the region of its blade airfoil;

FIG. 2 shows a cross-sectional view along the line II-II in FIG. 1;

FIG. 3 shows a cross-sectional view along the line III-III in FIG. 1;

FIG. 4 shows a perspective plan view of a basic body of the workpiece clamping device which is shown in FIG. 1;

FIG. 5 shows a perspective bottom view of the basic body which is shown in FIG. 4;

FIG. 6 shows a perspective partial view of the workpiece clamping device which is shown in FIG. 1, on the basic body of which a lower support device is fastened on the end face for supporting the turbine blade root;

FIG. 7 shows a perspective view of the workpiece clamping device which is shown in FIG. 1, on the basic body of which a lower support device and also two side support devices are fastened for supporting the turbine blade root; and

FIG. 8 shows a perspective view of a basic body of a workpiece clamping device according to a second embodiment of the present invention.

### DETAILED DESCRIPTION OF INVENTION

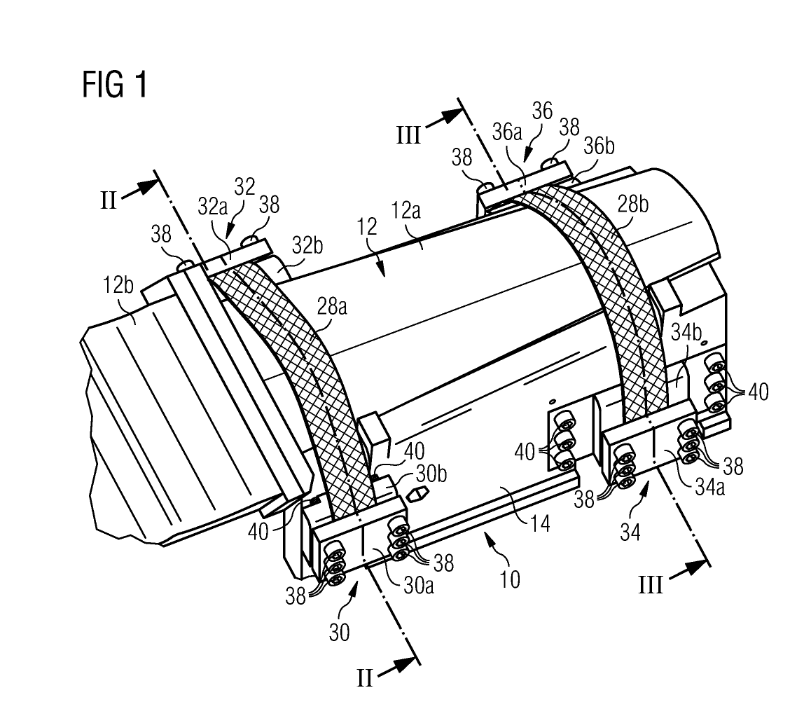

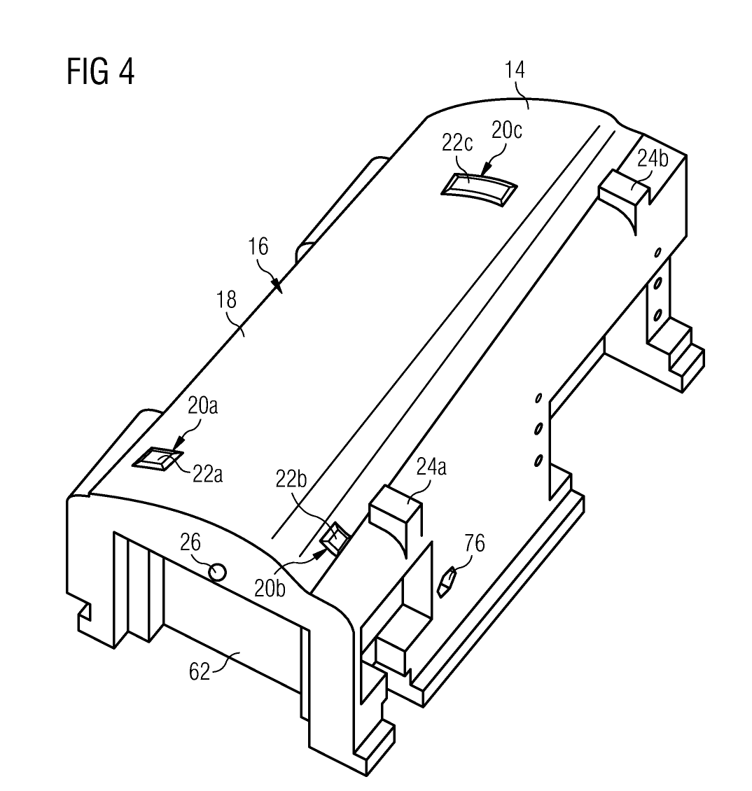

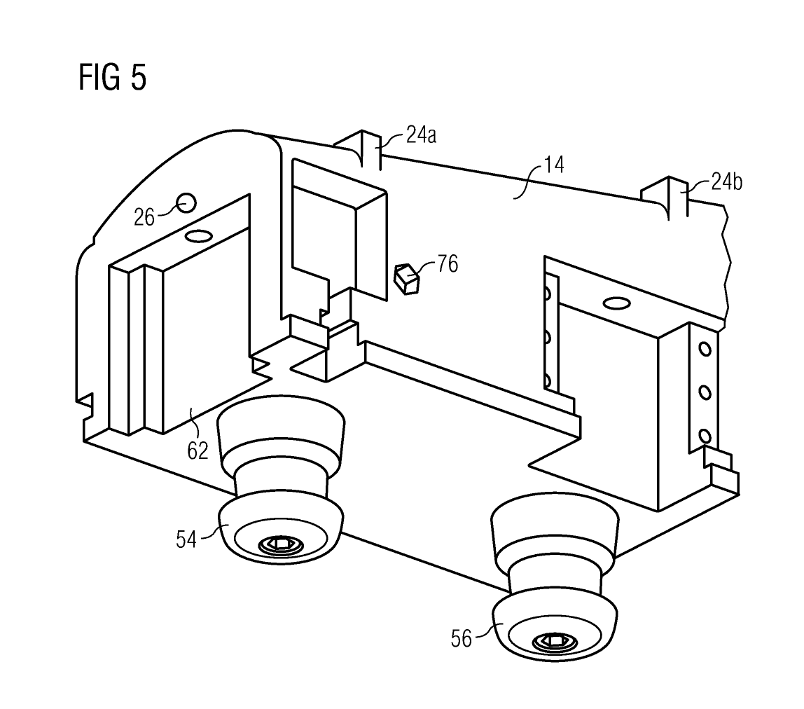

FIGS. 1 to 7 show a first embodiment of a workpiece clamping device 10 according to the invention, on which is clamped a workpiece in the form of a turbine blade 12 which has a blade airfoil 12a and a blade root 12b. The workpiece clamping device 10 comprises a basic body 14 consisting of metal, on the upper side of which a workpiece seat 16 for seating of the blade airfoil 12a of the turbine blade 12 is formed. The workpiece seat 16 comprises a base surface 18, the contour of which is essentially geometrically adapted to the outer contour of the underside of the blade airfoil 12a of the turbine blade 12. In addition, the workpiece seat 16 has three support elements 20 which project from the base surface 18, are geometrically adapted to the contour of the underside of the blade airfoil 12a, and in each case define a support surface 22 on which rests the underside of the blade airfoil 12a of the turbine blade 12. As a result of these support elements 20 a stable three-point bearing is created.

A predetermined positioning of the turbine blade 12 on the workpiece seat 16 is achieved via two blade airfoil stops 24 and a blade root stop 26. The two blade airfoil stops 24 are arranged at a distance from each other on the side alongside the workpiece seat 16 and are provided as projections which are formed in one piece with the basic body 14 and project upwards. In the case of the blade root stop 26, it is an essentially semicircular projection which projects outwards in the direction of the blade root 12b from the end face of the basic body 14 which points towards the blade root 12b.

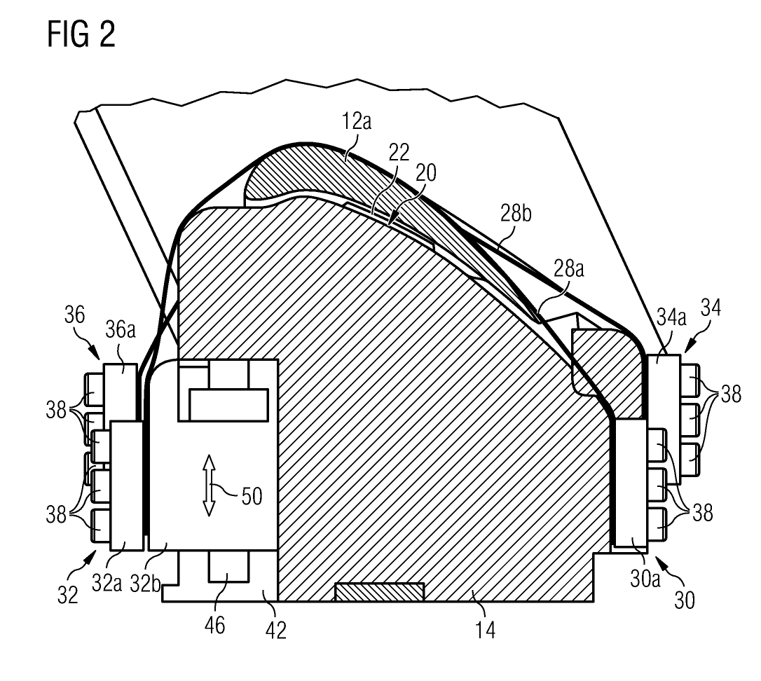

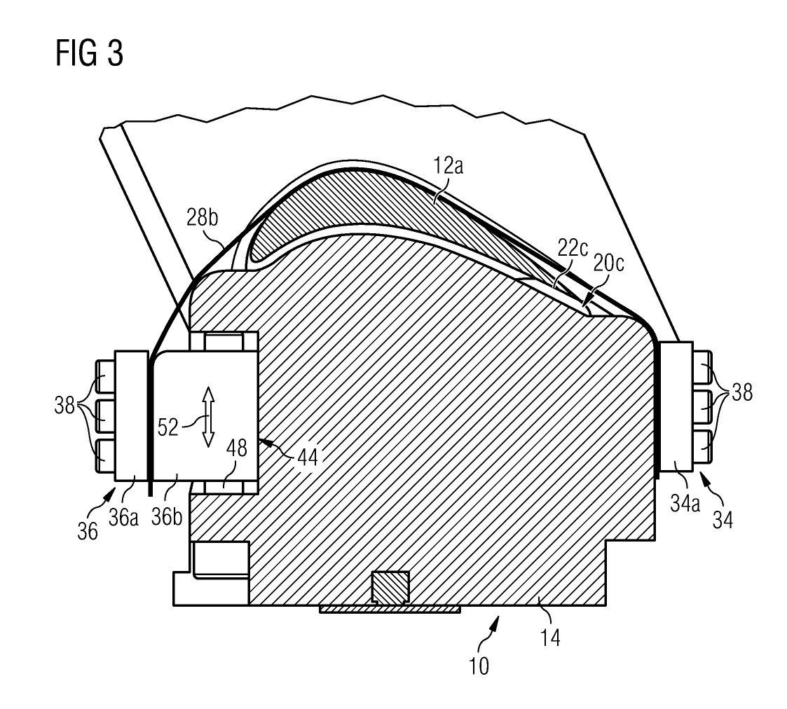

For clamping the turbine blade 12 which is arranged on the workpiece seat of the basic body 14, the workpiece clamping device 10 comprises two clamping straps 28a and 28b. The clamping straps 28a, 28b are held in each case on two clamping devices 30 and 32, or 34 and 36, which are provided on the basic body 14 on the sides and opposite each other. The clamping straps are produced in each case from a fibrous material, wherein the fibrous material is a fabric with high resistance to tearing. The clamping devices 30, 32, 34 and 36 in each case comprise two oppositely disposed clamping plates 30a, b, 32a, b, 34a, b and 36a, b which are detachably interconnected via fastening screws 38 and with clamping effect grip the clamping strap 28a or 28b which is arranged between them. The clamping straps 28a and 28b extend upwards from the clamping devices 30 and 34 which are fastened on the side of the basic body 14, wrap around the blade airfoil 12a of the turbine blade 12 and are then guided downwards again towards the clamping devices 32 and 36 which are arranged on the opposite side of the basic body 14. Whereas the clamping devices 30 and 34 are fixed in a stationary manner on the basic body 14 via fastening screws 40, the clamping devices 32 and 36 are functionally connected in each case to an automatic tensioning device 42, 44, more precisely to an essentially vertically extending piston rod 46, 48 of a hydraulic linear motor which forms the tensioning device 42, 44. Accordingly, the clamping devices 32 and 36 are movable together with the associated piston rods 46 and 48 vertically upwards and downwards, as a result of which tensioning or slackening of the associated clamping straps 28a and 28b is selectively carried out, as is indicated by means of the arrows 50 and 52 in FIGS. 2 and 3. The tensioning devices 42 and 44 are formed in such a way that they automatically tension the associated clamping strap 28a, 28b until achieving a predetermined clamping force, wherein the predetermined clamping force is adjustable by a user within predetermined limits.

On the underside of the basic body 14 are fastened two draw-in bolts 54 and 56 which serve for fastening the workpiece clamping device 10 on zero-point clamping systems of different machine tools (not shown) in order to be able to machine the turbine blade 12 accordingly.

If machining of the turbine blade 12 has to be carried out in different machine tools, then the entire workpiece clamping device 10, together with the turbine blade 12 which is clamped in this, can be removed from the zero-point clamping system of one machine tool and arranged on a further zero-point clamping system of another machine tool. Reclamping of the turbine blade 12 itself is therefore no longer necessary. Rather, the workpiece clamping device 10 can be transported with the turbine blade 12 held within this from one machine to the next.

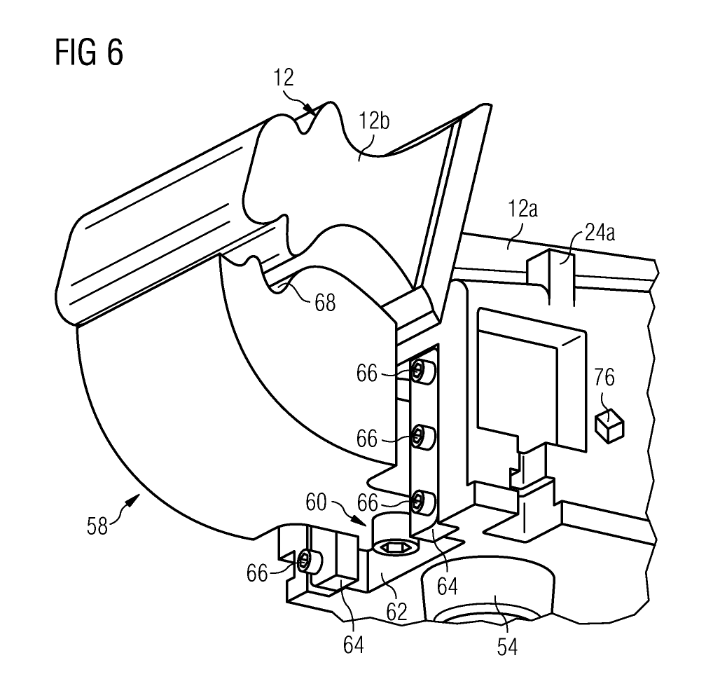

As is shown in FIG. 6, a blade root support device 58 can be fastened on the end face of the basic body 14 which points towards the blade root 12b of the turbine blade 12. The support device comprises an essentially T-shaped fastening section 60 which can be inserted into an essentially vertically extending fastening slot 62, which is formed on the end face of the basic body 14, and can be fixed in this slot in a clamped manner via clamping rails 64. The clamping is carried out by the clamping rails 64 being pressed onto the fastening section 60 of the blade root support device 58 by the drawing up of clamping screws 66, creating a frictional connection. The blade root support device 58 additionally comprises a support surface 68 which is geometrically adapted to the underside of the blade root 12b which faces it and during machining of the turbine blade 12 abuts against this and supports the blade root 12b.

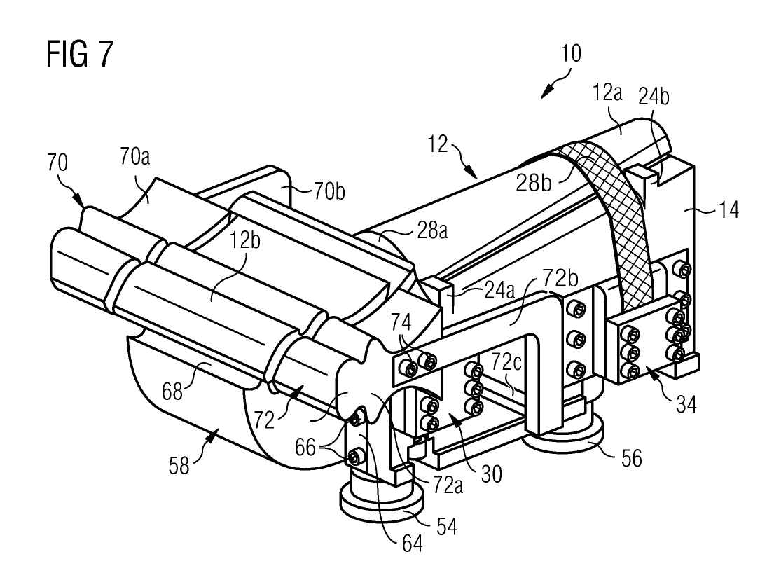

For influencing the fluid flow of a cooling fluid during material-removing machining of the blade root 12b, for example during machining by grinding, cooling fluid devices 70 and 72 can be fixed on the basic body 14, as is shown in FIG. 7. The cooling fluid devices 70 and 72 in each case comprise a cooling fluid plate 70a, 72a which is detachably connected via fastening screws 74 to one free end of an essentially L-shaped retaining element 70b, 72b and which is formed corresponding to the intended fluid flow. On the other free end of each retaining element 70b, 72b, a fastening rod 70c, 72c, which has a hexagonal cross section and extends essentially perpendicularly to the extension plane of the associated retaining element 70b, 72b, is fixed in each case. The fastening rods 70c, 72c are inserted into correspondingly dimensioned hexagonal openings 76 which are formed in the basic body 14 on the side.

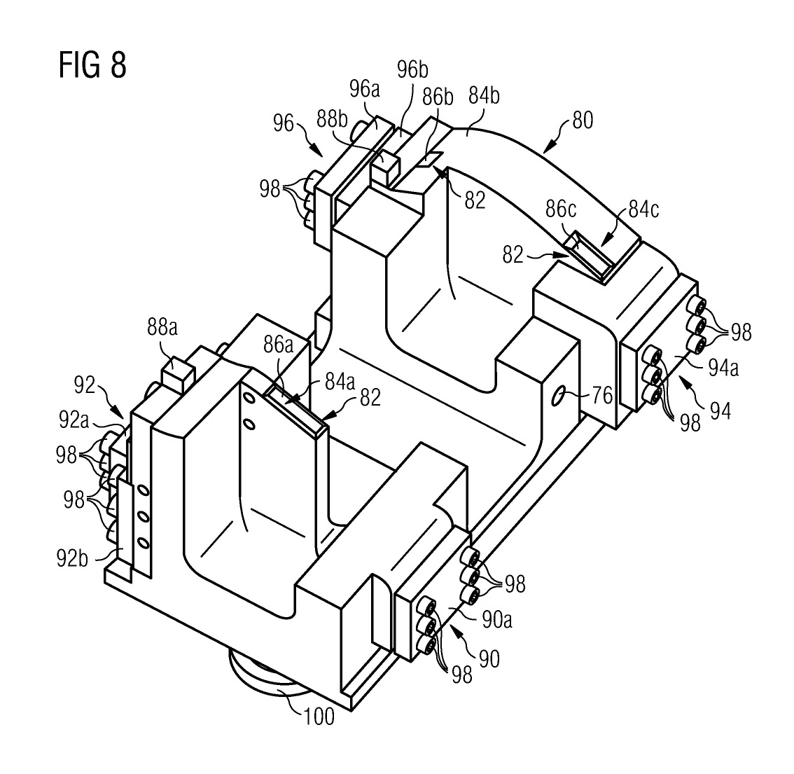

FIG. 8 shows a metal basic body 80 of a workpiece clamping device according to a second embodiment of the present invention. The basic body 80 comprises a workpiece seat 82 which has three support elements 84a, 84b and 84c which are formed in one piece with the basic body 14 and in each case define a support surface 86a, 86b and 86c for the seating of an underside of a blade airfoil 12a of a turbine blade 12 and which is geometrically adapted to the underside of the blade airfoil 12a. In this way, like in the case of the workpiece clamping device 10 which is shown in FIGS. 1 to 7, a workpiece seat in the style of a three-point bearing is created. In addition, the basic body 14 comprises two blade airfoil stops 88a and 88b in the form of projections which are formed in one piece with the basic body 80 and project upwards, against which the blade airfoil 12a of the turbine blade 12 comes to abut on the side. In addition, a blade root stop, which is not shown in more detail in FIG. 8, is formed on the end face of the basic body 14 which faces the blade root 12b of the turbine blade 12, as was previously described earlier with reference to the first embodiment. A predetermined positioning of the turbine blade 12 on the basic body 14 can be achieved accordingly.

Two clamping straps, which are not shown in more detail in FIG. 8, serve for clamping the turbine blade 12 on the basic body 14 and in each case are gripped in a clamped manner between two oppositely disposed clamping devices 90 and 92, or 94 and 96, which are provided on the basic body 14. The clamping devices 90 and 94 in each case comprise a clamping plate 90a, 94a which can be detachably fixed on the basic body 80 by means of fastening screws 98 in order to grip a clamping strap in a clamped manner between the clamping plate 90a, 94a and the basic body 80. The other two clamping devices 92 and 96 in each case comprise two clamping plates 92a and 92b, or 96a and 96b, which, by using fastening screws 98, can be fixed to each other so that a clamping strap can be gripped between these in a clamped manner. Although this is not to be seen in FIG. 8, the clamping devices 92 and 96, like in the case of the first embodiment, are functionally connected in each case to an automatic tensioning device, more precisely to an essentially vertically extending piston rod of a hydraulic linear motor which forms the tensioning device. The clamping devices 92 and 96, by operating the linear drive, can be moved together with the associated piston rods upwards and downwards accordingly in order to selectively tension or to slacken the associated clamping strap in this way.

Two draw-in bolts 100, which serve for fastening the basic body 80 on zero-point clamping systems of different machine tools in order to be able to machine the turbine blade 12 accordingly, are fastened on the underside of the basic body 80. Just as in the case of the first embodiment, a blade root support device and/or one or more cooling fluid guiding devices can also be fastened on the basic body 80.

The basic body 80, compared with the basic body 14 which is shown in FIGS. 1 to 7, is less solidly formed, as a result of which especially weight is saved, which facilitates transporting of the basic body 80 from one machine tool to the other.

1.-14. (canceled)

15. A workpiece clamping device for clamping a workpiece during machining, comprising:
a basic body including a workpiece seat; and
a clamping strap for clamping the workpiece.

16. The workpiece clamping device as claimed in claim 15, wherein the clamping strap comprises a fibrous material.

17. The workpiece clamping device as claimed in claim 16, wherein the fibrous material is a fabric with a high resistance to tearing.

18. The workpiece clamping device as claimed in claim 15, wherein the clamping strap is fixed on the basic body with a capacity for an adjustment in a clamping length of the clamping strap.

19. The workpiece clamping device as claimed in claim 15, wherein the workpiece seat is at least partially formed using a plurality of support elements which define a plurality of support points or support surfaces.

20. The workpiece clamping device as claimed in claim 19,
wherein the workpiece seat is at least partially defined using a support surface, and
wherein a contour of the support surface is at least partially geometrically adapted to an outer contour of the workpiece which is to be clamped.

21. The workpiece clamping device as claimed in claim 19, wherein the plurality of support elements are either each formed as one piece with the basic body or may be fastened as separate components on the basic body.

22. The workpiece clamping device as claimed in claim 15, wherein the basic body includes a plurality of clamping devices which fix the clamping strap.

23. The workpiece clamping device as claimed in claim 22, wherein the plurality of clamping devices are two oppositely disposed clamping plates which may be screwed towards each other with the clamping strap disposed between the two oppositely disposed clamping plates.

24. The workpiece clamping device as claimed in claim 15, further comprising an automatic tensioning device which automatically tensions the clamping strap until achieving a predetermined clamping force.

25. The workpiece clamping device as claimed in claim 24,
wherein the automatic tensioning device comprises a linear motor, and
wherein on a piston rod of the linear motor a clamping device is fastened.

26. The workpiece clamping device as claimed in claim 15, wherein the basic body may be detachably mounted on a plurality of different workpiece processing machines.

27. The workpiece clamping device as claimed in claim 26, wherein the basic body may be detachably mounted in a workpiece processing machine using a zero-point clamping system.

28. The workpiece clamping device as claimed in claim 27, wherein the basic body includes a tensioning element which interacts with the zero-point clamping system.

29. The workpiece clamping device as claimed in claim 28, wherein the tensioning element is a draw-in bolt.

30. The workpiece clamping device as claimed in claim 15, wherein a workpiece support device may be fastened on the basic body in such a way that the support surface, which is a surface of the workpiece support device, comes into contact with the workpiece.

31. The workpiece clamping device as claimed in claim 15, wherein a cooling fluid guiding device may be fastened on the basic body in such a way that a fluid flow of a cooling fluid is influenced in a predetermined manner during material-removing machining of the workpiece.

32. The workpiece clamping device as claimed in claim 15,
wherein the workpiece is a turbine blade, and
wherein the turbine blade is clamped in a region of a turbine blade airfoil.

33. The workpiece clamping device as claimed in claim 32,
wherein the workpiece seat is at least partially defined using a support surface, and
wherein a contour of the support surface is at least partially geometrically adapted to an outer contour of the turbine blade which is to be clamped.
